(19) United States
(12) Patent Application Publication
(10) Pub. No.: US 2007/0118415 A1
(43) Pub. Date: May 24, 2007

(54) Intelligent meeting scheduler

(75) Inventors: Liren Chen, San Diego, CA (US); Jack Steenstra, San Diego, CA (US); Kirk S. Taylor, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/258,674

(22) Filed: Oct. 25, 2005

(51) Int. Cl. G05B 19/418; G06F 9/46

(52) U.S. Cl. 705/8

(57) ABSTRACT

A method, apparatus, and system for implementing a intelligent meeting scheduler that accounts for the travel time and distances of the meeting participants. Some features of the meeting scheduling system include (1) scheduling meetings, (2) calculating travel time to the meeting for each participant, (3) adjusting individual participants schedules to include travel time and travel conditions, (4) determining scheduling conflicts, (5) suggesting scheduling dates, times, and/or locations, and/or (6) providing each meeting participant with timely notifications with sufficient time to arrive at the scheduled meeting.

### BACKGROUND

1. Field

The present invention generally relates to meeting scheduling systems, and more specifically to providing meeting notifications that account for travel distances, locations, and times of meeting participants.

2. Background

In large enterprise environments, facilities are often spread over a relatively large geographical area. When scheduling meetings in such large enterprises, it is each participant's responsibility to take into account and estimate their travel time to the meeting place in order to arrive on time. One of the main reasons participants arc late to meetings is that current meeting scheduling systems are not capable of automatically reserving “commute time” between locations. Another problem with current scheduling systems is that meeting reminders are not based on the actual conditions that affect how long it takes to get to the meeting location. Participants either leave too earlier and waste their time, or leave “on time” and get stuck in traffic, missing an important appointment.

Current scheduling systems depend on each meeting participant to allocate travel time between meetings and adjust their schedules accordingly. Current scheduling applications offer time-based reminders for upcoming meetings, which fail if the participant has to travel a long distance to the appointment or if traffic conditions change.

For example, on a large industrial campus, building locations may be miles apart from one another. When a meeting participant has a meeting scheduled for 9:00 AM, for example, at one end of the campus and the participant is located at the other end, the participant would have to leave with sufficient time to travel the distance. Current systems have standard reminders for meetings that are generally in five-minute increments and are set by the participant. This system does not accurately take into account the travel time required to reach the meeting location, or current travel conditions. Further, if there is second meeting scheduled after the 9:00 AM meeting, there are no automated conflict checks that warns a participant that there is insufficient time to travel to the second meeting and arrive on time.

### SUMMARY

One example of the invention provides an intelligent scheduler that can: 1) identify the preset location of meeting participants and automatically adjust schedules to allow for travel time; 2) automatically check for scheduling conflicts of meeting participants and resources such as meeting locations, projectors, teleconferencing equipment, catering, etc.; 3) automatically select or suggest a time neutral location based on travel time presets and participant priority rules; and/or (4) allow time for travel conditions.

One implementation provides an apparatus for use in a meeting scheduling application, comprising (a) an input interface to obtain a meeting location, date, and time, and a meeting participant list, (b) a processing circuit configured to (1) determine whether the schedules of meeting participants conflict with the meeting date and time; (2) determine a travel time for each meeting participant; and (c) an output interface to (1) send a notification if a conflict exists with a participant's schedule, and (2) transmit an alert to each meeting participant of the meeting just in time to permit each meeting participant to arrive at the meeting location on time. The processing circuit may be further configured to (a) calculate a travel time for a first meeting participant to travel from a first location associated with the first meeting participant to the meeting location; (b) notify the first participant of the meeting with sufficient time to permit the first participant to travel from the first location to the meeting location; (c) receive a second location information from the first meeting participant; and (d) transmit a new meeting alert to the first meeting participant that accounts for the time it takes to travel from the second location to the meeting location. The travel time may be calculated by (a) determining a travel distance between the first location and the meeting location; and (b) dividing the travel distance by a travel rate to determine the travel time. The first location may be a preset location associated with the first meeting participant. Additionally, the notification may be sent to the first participant moments prior to the meeting time, accounting for the travel time between the first location and the meeting location. The processing circuit may be further configured to (a) obtain current travel condition information for the path between the first location and the meeting location; (b) account for travel conditions in calculating the travel time; (r) determine a route to take from the first location to the meeting location; (d) transmit the route to the first participant; (e) check for a scheduling conflict of the meeting location; (f) generate an alternative meeting location, time, or date if a conflict exists; (g) check for a scheduling conflict with the first participant's schedule; and/or (h) if a conflict exists, send a notification of the conflict.

Another embodiment provides a meeting notification method comprising (a) obtaining a meeting location; (b) receiving a list of the meeting participants; (c) automatically determine a travel time for each meeting participant; and/or (d) sending each meeting participant a meeting alert just in time to permit each meeting participant to arrive to the meeting location on time. The method may further comprise (a) obtaining a meeting time and date; (b) obtaining a first location associated with a first participant; (c) determining the travel time between the first location and the meeting location; (d) determining a travel route to take from the first location to the meeting location; (e) transmitting the route to the first participant; (f) monitoring the location of the first participant; (g) notifying other participants if the first participant is going to be tardy to the meeting; (h) determining a convenient meeting location for the meeting participants by minimizing the overall travel times of the combined participants; and/or (i) suggesting such convenient location as the meeting location. Sending each meeting participant a meeting alert includes (a) sending a meeting alert to the first participant moments before the meeting time, and (b) accounting for the travel time to get from the first location to the meeting location.

Yet another embodiment provides a machine-readable medium having one or more instructions for scheduling meetings, which when executed by a processor causes the processor to (a) receive a meeting location, date and time; (b) receive a list of the meeting participants; (c) calculate a travel time for the first meeting participant to travel from a first location associated with the first meeting participant to the meeting location; and (d) notify the first participant of the meeting with sufficient time to permit the first participant to travel from the first location to the meeting location. The travel time may be calculated by (a) determining a travel distance between the first location and meeting location; and (b) dividing the travel distance by a travel rate to determine the travel time. Additionally, the travel time may be obtained from list of predetermined travel times from the first location to the meeting location. The notification may be sent to a terminal associated with the first participant moments prior to the meeting time, accounting for the travel time and travel conditions between the first location and the meeting location.

### BRIEF DESCRIPTION OF THE DRAWINGS

FIG. 1 is a block diagram illustrating one example of an intelligent meeting scheduling system.

FIG. 2 is a block diagram illustrating a meeting scheduling system.

FIG. 3 is a flowchart illustrating an example of a scheduling application that calculates travel time from preset information.

FIG. 4 is a flowchart illustrating an example of a scheduling application that automatically checks for scheduling conflicts.

FIG. 5 is a flowchart illustrating an example of a scheduling application that suggests a meeting date and time based on participants' schedules.

FIG. 6 is a flowchart illustrating an example of a scheduling application that suggests a meeting location based on participants' locations.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through any suitable means including memory sharing, message passing, token passing, network transmission, etc.

As used herein, an intelligent scheduling application or system includes any program, code, applet, routine, or other such machine or processor implemented algorithm that uses the stored or real-time location of one or more meeting participants to provide scheduling information and notifications to the meeting participants. Examples of such intelligent scheduling applications include programs that can: 1) identify the preset location of meeting participants and automatically adjust schedules to allow for travel time; 2) automatically check for scheduling conflicts of meeting participants and resources such as meeting locations, projectors, teleconferencing equipment, catering, etc.; 3) automatically select or suggest a time neutral location based on travel time presets and participant priority rules; and/or (4) allow time for travel conditions.

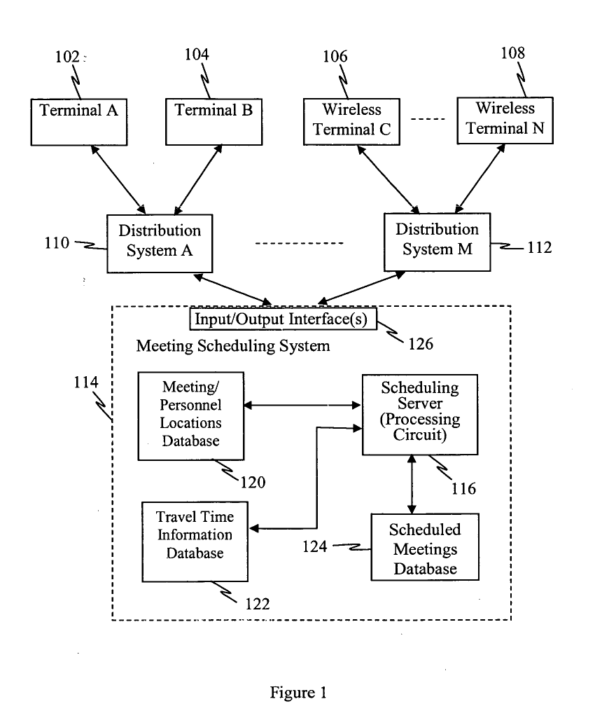

FIG. 1 is a block diagram illustrating one example of an intelligent meeting scheduling system 114 in which one or more scheduling services/features may be implemented. One or more terminals 102, 104, 106 and 108, may be communicatively coupled to meeting scheduling system 114. One or more distribution systems 110 and 112 serve to distribute messages or information between meeting scheduling system 114 and one or more terminals 102, 104, 106 and 108. Distribution systems 110 and 112 may provide a scalable interface between terminals 102, 104, 106, and 108 and input/output interfaces 126 of the scheduling system 114.

According to one feature of meeting scheduling system 114, the system 114 provides location-based meeting scheduling services to one or more meeting participants. For example, when a meeting is scheduled the names of participants are entered and their locations (e.g., office or building) are identified. A participant's location may be his/her regular office location or a real-time location. This location information is accessible to the meeting scheduling system 114 for providing timely location-based notifications to meeting participants that accounts for travel time, traffic, distances, etc.

The meeting scheduling system 114 may provide timely meeting notifications (e.g., text message, email, graphic alerts, audio alerts, etc.) to meeting participants (e.g., anyone invited to the meeting) through terminals 102, 104, 106 and 108. Terminals 102, 104, 106 and 108 may be computers, laptop computers, personal digital assistants (PDA) or wireless devices, such as mobile phones, pagers, wireless modems, personal information managers, handheld computers, and/or other communication/computing devices capable of receiving notifications from an intelligent meeting scheduling application running on scheduling server 116. Terminals 102, 104, 106 and 108, may be configured to receive meeting schedules and notifications, and transmit a participant's location, an acceptance/rejection to attend a scheduled event, etc. Terminals 102, 104, 106 and 108 may transmit to and/or receive information from a network of distribution systems 110 and 112 over wired and/or wireless links.

Distribution systems 110 and 112 are capable of receiving information from, and transmitting information to, terminals 102, 104, 106 and 108 over wired and/or wireless links. Distribution systems 110 and 112 may include various components such as base stations, base station controllers (BSCs), mobile switching centers (MSCs), relay devices, networks, etc.

Scheduling server 116 runs an intelligent meeting scheduling application that provides meeting scheduling, conflict checking, meeting resource allocation, user notifications, and/or availability checking. Having knowledge of participant locations and meeting location information, scheduling server 116 can request or determine travel times and/or distance and, travel conditions, such as traffic information, weather information, road construction/maintenance, road closures, etc., from one or more databases or sources. The travel conditions may be real-time, current, or historical information used for predicting a travel time. Scheduling server 116 then adjusts each participant's travel time and sends a timely notification or alert to the meeting participants that they should depart from their current location to the meeting place at a particular time.

Scheduling server 116 may include a processor, circuit, memory and/or application(s) and database(s) configured to determine an individual participant's location and (1) estimate travel time based on the individual participant's preset or real-time location, (2) estimate travel time based on the individual participant's current location, (3) provide real-time traffic information, and/or (4) provide alternative travel routes (e.g., shortest time, shortest distance, least congested, etc.), or other time and travel related information. The scheduling server 116 may also notify or alert a participant of the meeting with sufficient time to permit the first participant to travel from the first location to the meeting location.

A meeting/personnel location database 120 contains the preset meeting locations on a campus. It may also contain preset or configurable locations of all offices, cubicle, workspaces, etc., of all personnel who work at the campus. When new buildings are added, personnel change location or new personnel are employed, the database are updated to reflect the new location. Additionally, one implementation may include real-time participant location by racking the location of a meeting participant or having knowledge of his/her meeting schedule.

A time-of-travel and/or distances database 122 includes travel time and/or distances between locations on a campus. In one implementation, the distances are all measured from a designated point and can be entered through a database program, or directly by a system administrator. The travel time may include real-time, current, or historical information about travel conditions, such as traffic information, weather information, road construction/maintenance, road closures, etc.

This location and travel time/distance information can then be used by scheduling server 116 to provide timely notifications to meeting participants. Such notifications may be sent to a participant moments (e.g., five minutes, one minute, etc.) before he/she should depart to arrive at the meeting on time. The time-of-travel/distances and location databases may also include maps, directions, etc., that are sent to a meeting participant, either automatically or upon request, to help the participant to travel from his/her current location to the meeting location.

The scheduling server 116, distribution systems 110 and 112, meeting and personnel location database 120, and travel time information database 122 are interconnected to transfer information there between. The meeting and personnel location database 120 and the travel time information database 122 serve as the backbone of the intelligent scheduling application and services provided by the meeting scheduling server 116. As such, these databases may be highly-available, flexible, redundant, and deliver high-performance and salability.

While the exemplary meeting scheduler described herein is for a campus implementation, the intelligent scheduling server 116 may be applied to scheduling meetings at any distances (e.g., across a city, county, or region). In such implementations other features may be added to the intelligent scheduling server 116. For example, a historical or real-time traffic database may enable the system to take into account traffic/commute information when determining travel time to send a participant a meeting reminder or notification.

Depending on the application running on terminals 102, 104, 106 and 108 and terminal resources (e.g., memory, display capabilities, communication capabilities, processing capabilities, etc.), the meeting scheduling server 116 may provide various levels of travel detail or information including, but not limited to, digital maps, text directions, artificial voice directions, etc., when sending a meeting notification or upon request by a meeting participant. The meeting scheduling server 116 may contain mapping and direction algorithms that supports travel time estimates, real-time traffic updates, and/or location information.

One feature may provide a participant's current location information and status (e.g., attending versus not attending, delayed, etc.). This way, meeting participants can be appraised of the geographical proximity of other participants, their estimated arrival time at the meeting location, and whether the participant will be attending.

Another feature may enable a user to specify or update travel time during transit. For example, a participant caught in traffic may send an update to the scheduling system 114. The system can then update and send notifications or new schedule information to all other participants who may decide to adjust their travel plans accordingly.

Another feature may provide real-time tracking of participants by using global positioning system (GPS)-enabled terminals and automatically updates an individual participant's terminal location. That is, the terminals send their position to the intelligent meeting scheduling application its position information. In this manner, participants at the meeting location are be able to determine a missing attendee's estimated arrival time by checking the meeting schedule tracking feature. The intelligent scheduling application may continuously or periodically update individual participant's location.

Another function of scheduling system 114 is to deliver alerts to terminals 102, 104, 106 and 108 based on the participant's location, traffic conditions, distance to the meeting location, etc. For example, the intelligent scheduling application may calculate an estimated arrival time of a participant in bad traffic. The intelligent scheduling application then sends alerts to all meeting participants, if the participant will not arrive on time.

Yet another feature provides a scheduled meetings database 124 which stores meeting schedules and can be accessed by the intelligent scheduling application running in the scheduling server 116 to check for meeting conflicts and/or provide meeting schedules, notifications, or reminders to participants.

One or more of the components and functions illustrated in FIG. 1 may be rearranged and/or combined into a single component or embodied in several components without departing from the invention. Additional elements or components may also be added without departing from the invention.

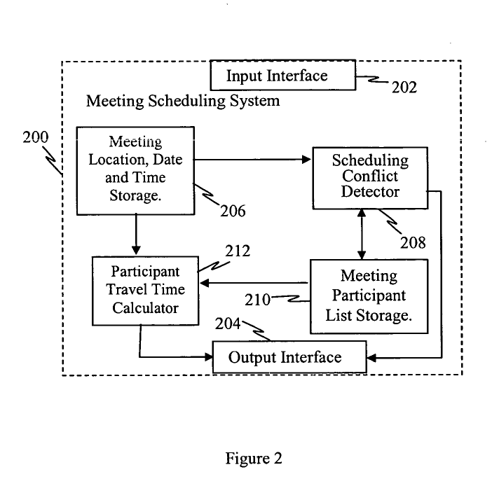

FIG. 2 is a block diagram illustrating a meeting scheduling system 200. Input interface 202 can receive information from user terminals while output interface 204 can send alerts and/or notifications to user terminals. Meeting location, date, and time storage 206 contains information about scheduled meetings. Scheduling conflict detector 208 determines whether a conflict exists between a scheduled meeting and the schedules of the meeting participant(s) and, if so, sends a notification of such conflict. Meeting participant list storage 210 may store a list of participants for a particular meeting. A participant travel time calculator 212 may obtain the list of participants for a meeting, calculate the travel time from a participant's preset location to the meeting location, and send a notification to the meeting participant to depart in time to arrive at the meeting on time.

One or more of the components and functions illustrated in FIG. 2 may be rearranged and/or combined into a single component or embodied in several components without departing from the invention. Additional elements or components may also be added without departing from the invention.

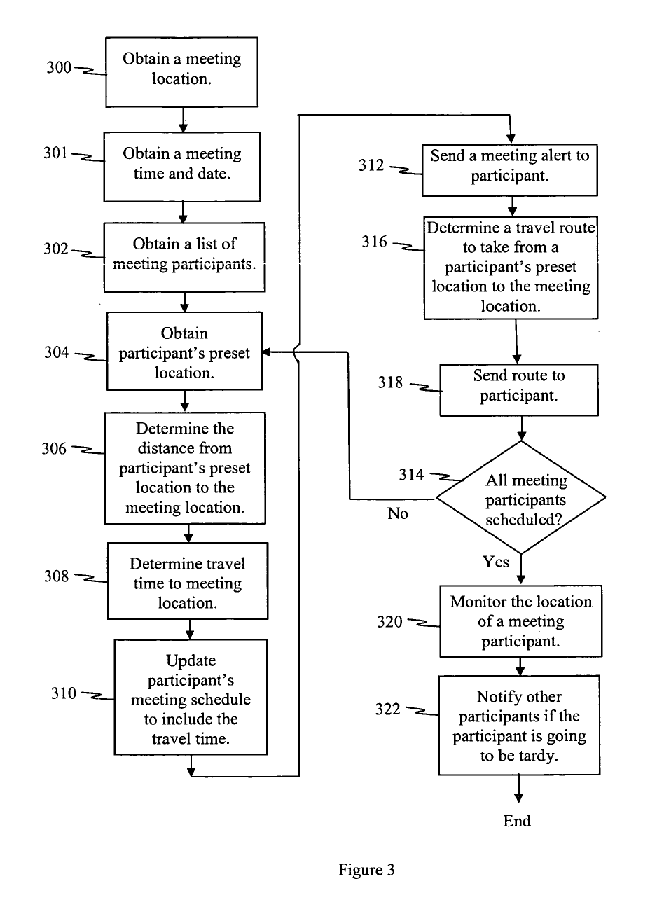

FIG. 3 is a flowchart illustrating an example of a scheduling application that calculates travel time from preset information. Generally, a meeting is scheduled by defining a meeting location, place and time, and notifying the meeting participants. The intelligent scheduling application obtains a meeting location 300 and a time and date 301. A list of participants is then obtained 302. The scheduling application then obtains each participant's preset location 304. The distance between the meeting location and the meeting participant's preset location is calculated 306. A travel time is then calculated from the participant's location to the meeting location 308. Such travel time may take into account the method of transportation used by the participant (e.g., by foot or by car, etc.) and other information, such as whether elevators/stairs will be taken, security checks for a particular building, parking delays, travel conditions, etc. The participant's meeting schedule 310 is then updated to include the travel time to the meeting, thus accurately reflecting when the participant should leave for the meeting. The schedule/notification with the added travel time may then be transmitted to the meeting participant 312. Such notification may be sent to the participant days, hours, or minutes ahead of the meeting or moments before the participant should depart to be on time for the meeting. The intelligent meeting scheduling application then checks whether all participants have been scheduled 314 and repeats the process until all participants have been scheduled and notified. In various implementations, the intelligent meeting scheduling application continuously or periodically recalculates travel time and/or distances ahead of the meeting and provides updated notifications if travel time or conditions have changed.

According to one optional feature, a travel route from a participant's preset location to the meeting location is determined 316 and sent to the meeting participant 318. Another feature optionally provides for monitoring the real-time location of a meeting participant 320 and notifying the other participants if a participant is going to be tardy 322 to the meeting.

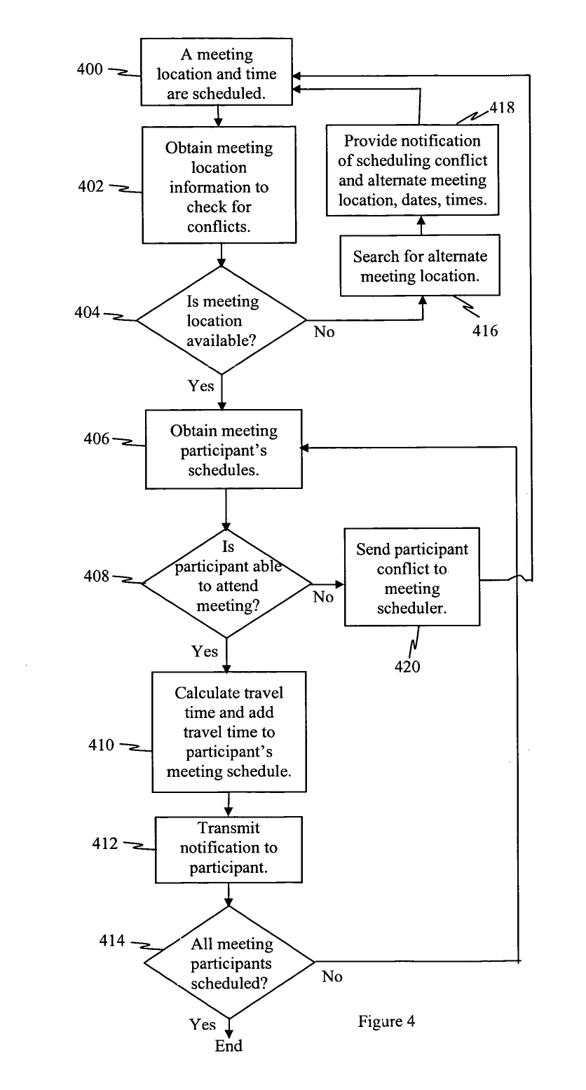

FIG. 4 is a flowchart illustrating an example of a scheduling application that automatically checks for scheduling conflicts. A meeting place and time is scheduled using the intelligent scheduling application 400. Meeting location information is obtained to check for possible scheduling conflicts 402. For each meeting location, scheduled meeting times are checked against previously scheduled meetings 404. If a meeting location and time is not available (e.g., the location is in used at the desired time), the scheduling application searches for alternate meeting locations, dates and/or times 416. The meeting scheduling application then notifies the person scheduling the meeting of the location, date, or time conflict and provides alternate meeting locations, dates and/or times 418.

If the meeting location is available at the desired date and time, the meeting scheduling application obtains the schedules for the meeting participants 406. Each participant's schedule is compared to the proposed meeting schedule 408 (e.g., dates and times are compared). If a participant has a scheduling conflict (e.g., two or more events are scheduled at the same or overlapping times), the scheduling application sends a notice of the conflict to person scheduling the meeting and/or the person having the conflict 420. The person scheduling the meeting then has the option of changing the meeting date, time or location to accommodate the invited participant's schedule, ignoring the scheduling conflict, or removing/uninviting the participant from the meeting. If the participant is available, the scheduling application calculates the travel time, adds that time to the participant's schedule 410, and transmit the schedule or notification, indicating departure time or travel time, to the participant 412. This conflict-checking process is repeated until all participants have been scheduled and all conflicts addressed 414.

In an alternative embodiment of the method illustrated in FIG. 4, the scheduling application also considers participant's schedules prior to the scheduled meeting to determine conflicts and/or provide sufficient travel time to the meeting. For example, a participant may have a first meeting just prior to a newly scheduled second meeting. The intelligent meeting scheduling application can use the first meeting's location to calculate travel time or distance to the second meeting location and send the participant a timely notification when he/she should depart to then second meeting. Another feature provides that when the intelligent scheduling system knows that a meeting participant is at a different location or meeting, it sends the participant reminders or departure notifications to his/her mobile terminal (e.g., mobile phone, pager, PDA, etc.).

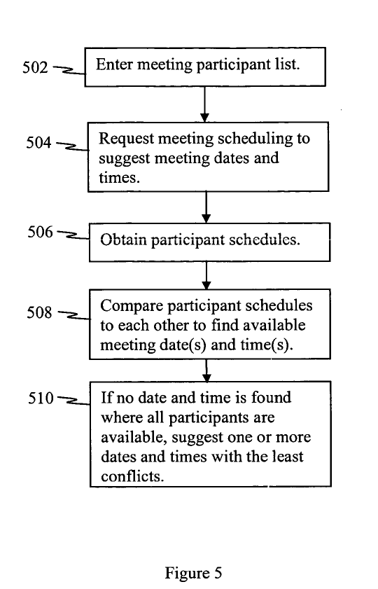

FIG. 5 is a flowchart illustrating an example of a scheduling application that suggests a meeting date and time based on participants' schedules. In some situations, a meeting organizer may wish to determine the best date and time to schedule a meeting. The meeting organizer may enter a list of names of the meeting participants 502 and request the scheduling application to provide it with the available dates and times 504 for the meeting. The meeting scheduling application obtains each participant's schedule, which may include other meeting information, holidays, planned vacation time, etc., 506 and compares the participants' schedules to each other to find an available date and time when the meeting participants can meet 508. The scheduling application then reports one or more available dates and times to the meeting organizer for selection 510. If no date and time is found where all participants are available, the scheduling application may report the best available date and time (e.g., the date and time when the participants have the least number of conflicts).

In one embodiment, the scheduling application may also permit the meeting organizer to the preferred date or time range of the meeting. In this manner, the scheduling application can limit its search for the best available dates and times.

Another feature provides of the meeting scheduling system optimizes the meeting location based on the location of the participants.

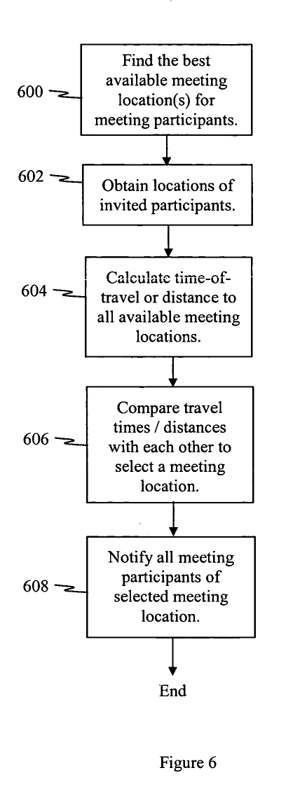

FIG. 6 is a flowchart illustrating an example of a scheduling application that selects or suggest a meeting location based on participants' locations. A meeting organizer schedules a meeting and instructs the scheduling application to find the best location for meeting participants on a particular date and time 600. The location of all invited participants is then retrieved or obtained 602. For all available meeting locations, the time-of-travel or distance is calculated for every participant 604. The application then compares all the travel times with each other to select a meeting location for which all participants have approximately the same travel time 606. The scheduling application notifies all participants of the selected meeting location 608.

Another feature of the scheduling application checks the number of participants attending the meeting before suggesting a meeting location. In this manner, an adequate and available meeting location is provided than can hold the number of expected participants. In such implementation, the scheduling application would have preset knowledge of the capacity of the meeting locations.

In an alternative embodiment of the method illustrated in FIG. 6, the scheduling application weights the travel times of participants versus the number of participants attending from one or more locations. For example, if nine meeting participants are in located in the same building and a single participant is located at a different building, then the intelligent meeting scheduling application can alert the person scheduling the meeting and suggest a location closest to the nine participants. Thereby only one person needs to travel to the meeting versus nine participants. This concept can be extrapolated to weight the choice of meeting locations so as to reduce the overall amount of travel by all participants.

In yet another alternative embodiment of the method illustrated in FIG. 6, the scheduling application weights the travel times for participants versus the importance of one or more participants. For example, the scheduling application may be told which participants arc “necessary” to the meeting versus nominal attendees. This way, the scheduling application may prioritize the necessary participants (e.g., meeting presenter, organizer, speaker, etc.) over all other participants. Thus, the location/time of the meeting may be selected to favor the necessary participants, even if it is inconvenient to other participants.

In yet another alternative embodiment of the method illustrated in FIG. 6, the scheduling application may suggest a meeting location, date, or time to favor one or more participants. For instance, the meeting scheduling application may consider the schedule of the meeting speaker in suggesting a meeting location, date, or time to prevent conflicts or travel conflicts with other scheduled meetings of the meeting speaker. That is, if the meeting speaker is scheduled to be in another meeting right before the newly scheduled meeting, the scheduling application may suggest that the meeting locations be close to each other.

Different types of intelligent scheduling applications may be implemented without departing from the invention. For example, one implementation may schedule meetings and provide on-time reminders to participants within an industrial campus. Another application may provide university students with class schedule notifications or reminder messages, adjusted for travel times between home/dorms and classrooms, to avoid tardiness. In another application, a sales representative may receive reminders on when to leave for client meetings, adjusted for travel time, traffic, etc. Generally, any business or service where people meet and confer with each other would benefit from the efficiency provided by the intelligent scheduler system described herein.

It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives., modifications, and variations will be apparent to those skilled in the art.

What is claimed is:

1. An apparatus for use in a meeting scheduling application, comprising:
an input interface to obtain a meeting location, date, and time, and a meeting participant list;
a processing circuit configured to
determine whether the schedules of meeting participants conflict with the meeting date and time, and
determine a travel time for each meeting participant; and
an output interface to
send a notification if a conflict exists with a participant's schedule, and
send an alert to each meeting participant of the meeting just in time to permit each meeting participant to arrive at the meeting location on time.

2. The apparatus of 1 wherein the processing circuit is further configured to:
calculate a travel time for a first meeting participant to travel from a first location associated with the first meeting participant to the meeting location; and
notify the first participant of the meeting with sufficient time to permit the first participant to travel from the first location to the meeting location.

3. The apparatus of 2 wherein the processing circuit is further configured to:
receive a second location information from the first meeting participant, and
transmit a new meeting alert to the first meeting participant that accounts for the time it takes to travel from the second location to the meeting location.

4. The apparatus of 2 wherein the travel time is calculated by
determining a travel distance between the first location and meeting location; and
dividing the travel distance by a travel rate to determine the travel time.

5. The apparatus of 2 wherein the first location is a preset location associated with the first meeting participant.

6. The apparatus of 2 wherein the notification is sent to the first participant moments prior to the meeting time, accounting for the travel time between the first location and the meeting location.

7. The apparatus of 2 wherein the processing circuit is further configured to:
obtain current travel condition information for the path between the first location and the meeting location; and
account for travel conditions in calculating the travel time.

8. The apparatus of 2 wherein the processing circuit is further configured to:
determine a route to take from the first location to the meeting location; and
transmit the route to the first participant.

9. The apparatus of 1 wherein the processing circuit is further configured to:
check for a scheduling conflict of the meeting location; and
generate an alternative meeting location, time, or date if a conflict exists.

10. The apparatus of 1 wherein the processing circuit is further configured to:
check for a scheduling conflict with a first participant's schedule; and
if a conflict exists, send a notification of the conflict.

11. An apparatus comprising
means for obtaining a meeting location, date, and time;
means for obtaining a meeting participant list;
means for determining scheduling conflict between the schedules of meeting participants and the meeting date and time;
means for determining a travel time for each meeting participant; and
means for sending a notification if a conflict exists with a participant's schedule, and
means for sending an alert to each meeting participant of the meeting just in time to permit each meeting participant to arrive at the meeting location on time.

12. The apparatus of 11 further comprising:
means for notifying another meeting participant is going to be tardy to the meeting.

13. A meeting notification method comprising:
obtaining a meeting location;
obtaining a list of the meeting participants;
automatically determining a travel time for each meeting participant; and
sending each meeting participant a meeting alert just in time to permit each meeting participant to arrive to the meeting location on time.

14. The method of 13 further comprising:
obtaining a meeting time and date;
obtaining a first location associated with a first participant; and
determining the travel time between the first location and the meeting location.

15. The method of 14 wherein sending each meeting participant a meeting alert includes sending a meeting alert to the first participant moments before the meeting time, accounting for the travel time to get from the first location to the meeting location.

16. The method of 14 further comprising:
determining a travel route to take from the first location to the meeting location; and
transmitting the route to the first participant.

17. The method of 14 further comprising:
monitoring the location of the first participant; and
notifying other participants if the first participant is going to be tardy to the meeting.

18. The method of 13 further comprising:
determining a convenient meeting location for the meeting participants by minimizing the overall travel times of the combined participants; and
suggesting such convenient location as the meeting location.

19. A machine-readable medium having one or more instructions for scheduling meetings, which when executed by a processor causes the processor to:
obtain a meeting location, date and time;
obtain a list of the meeting participants;
calculate a travel time for a first meeting participant to travel from a first location associated with the first meeting participant to the meeting location; and
notify the first participant of the meeting with sufficient time to permit the first participant to travel from the first location to the meeting location.

20. The machine-readable medium of 19 wherein the travel time is calculated by
determining a travel distance between the first location and meeting location; and
dividing the travel distance by a travel rate to determine the travel time.

21. The machine-readable medium of 19 wherein the travel time is obtained from list of predetermined travel times from the first location to the meeting location.

22. The machine-readable medium of 19 wherein the notification is sent to a terminal associated with the first participant moments prior to the meeting time, accounting for the travel time and travel conditions between the first location and the meeting location.

23. The machine-readable medium of 19 further comprising:
obtain current travel information for the path between the first location and the meeting location; and
account for travel conditions in calculating the travel time.

24. The machine-readable medium of 19 further comprising:
determine a route to take from the first location to the meeting location; and
send the route to the first participant.
